(19) United States
(12) Patent Application Publication
(10) Pub. No.: US 2003/0140907 A1
(43) Pub. Date: Jul. 31, 2003

(54) Flexible circuit connection for moving coil of an automotive emission control valve

(76) Inventors: Frederic Gagnon, Chatham (CA); Allen Tamman, Chatham (CA)

Correspondence Address: Siemens Corporation, Intellectual Property Department, 186 Wood Avenue South, Iselin, NJ, 08830, US

(21) Appl. No.: 10/259,062

(22) Filed: Sep. 27, 2002

Related U.S. Application Data
(60) Provisional application No. 60/354,006, filed on Jan. 31, 2002.

(51) Int. Cl. F02B 47/08; F16K 31/02

(52) U.S. Cl. 123/568.26; 251/129.15

(57) ABSTRACT

An electric actuated control valve, such as an EGR valve, has an actuator whose armature contains an electromagnet coil for operating the actuator. Current for the coil is conveyed through a flexible circuit between the armature and a housing of the actuator.

### REFERENCE TO A RELATED APPLICATION AND PRIORITY CLAIM

This application derives from the following commonly owned co-pending patent application, the priority benefit of which is expressly claimed: Provisional Application Ser. No. 60/354,006 filed on Jan. 31, 2002 in the names of Gagnon et al.

### FIELD OF THE INVENTION

This invention relates generally to electric-actuated control valves, such as emission control valves that are associated with automotive vehicle engines. More particularly, the invention relates to a control valve where electric current needs to be delivered to the armature of the actuator that positions a valve element relative to a valve seat. Principles of the invention are disclosed in an exemplary exhaust gas recirculation (EGR) valve.

### BACKGROUND OF THE INVENTION

The actuator of certain control valves comprises a solenoid that has an electromagnet coil that is energized by electric current to operate the valve. The electric current positions an armature of the actuator, with the armature motion being transmitted to a valve element to position the latter relative to a valve seat, thereby setting the restriction that the valve imposes on fluid flow through a body of the valve.

In some actuators, the electromagnet coil is disposed on a stator of a magnetic circuit having an air gap at which magnetic flux generated in the stator acts on the armature. The stator and coil are stationary on the actuator, and so electric current is delivered to the coil via terminals that are also stationary.

It has been discovered that certain attributes desired in an emission control valve can be obtained by mounting the coil on the armature rather than on the stator. One such attribute is the development of larger forces for operating the valve. Because the coil therefore moves with the armature, the electric connection between the moving coil and terminals that are stationarily mounted on the actuator to provide for connection of the coil with a remote source of electric current must accommodate the range of relative motion that can occur between the stator and the armature. Rather stringent demands from various sources, such as customers and government regulators, are imposed on emission control valves, and so a valve having a moving coil in its actuator must provide reliability and durability in the electric circuit connection leading to the coil.

### SUMMARY OF THE INVENTION

It is toward providing a valve of the latter type that the present invention is directed.

One general aspect of the invention relates to an electric-actuated automotive emission control valve comprising a valve body comprising a passageway having an inlet port for receiving fluid and an outlet port for delivering fluid. A valve element is selectively positioned to selectively restrict the passageway. A mechanism for selectively positioning the valve element comprises a solenoid actuator comprising a magnetic circuit that comprises a stator, an armature, and an electromagnet coil disposed on one of the stator and armature. The stator, the armature, and the coil are collectively arranged to cause the armature and the stator to be relatively positioned along an axis in correlation with electric current in the coil. Wiring conducts the electric current between a termination at the coil and a termination at the other of the stator and the armature. The distance between the terminations, as measured along the axis, changes in correlation with the electric current, and the wiring has an arcuate shape about the axis as viewed in the direction of the axis.

Another aspect relates to the solenoid actuator itself.

The accompanying drawings, which are incorporated herein and constitute part of this specification, include a presently preferred embodiment of the invention, and together with a general description given above and a detailed description given below, serve to disclose principles of the invention in accordance with a best mode contemplated for carrying out the invention.

### BRIEF DESCRIPTION OF THE DRAWINGS

FIG. 1 is a cross section view, in elevation, of an exemplary embodiment of an actuator of a valve embodying principles of the present invention, with the valve element and valve seat being portrayed schematically.

FIG. 2 is a horizontal view in the direction of arrows 2-2 in FIG. 1.

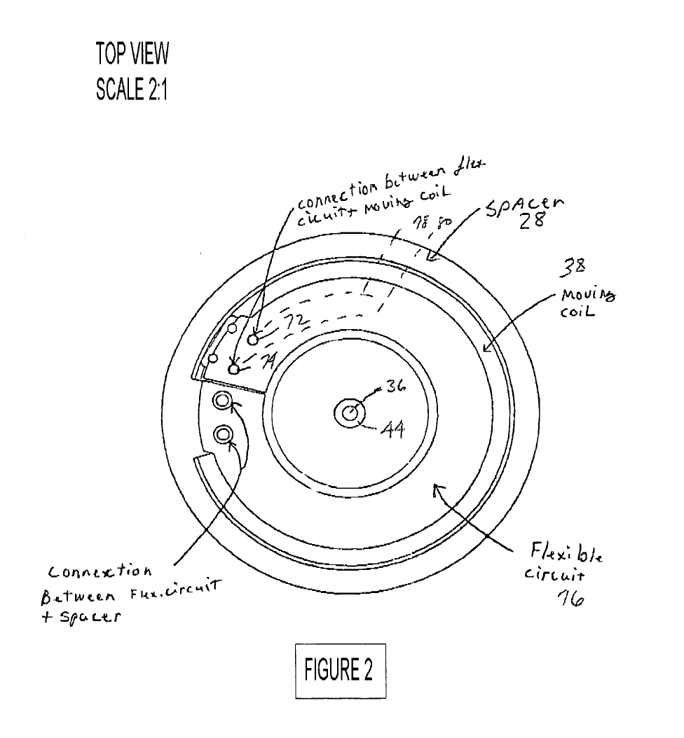

FIG. 3 is an exploded perspective view of the actuator.

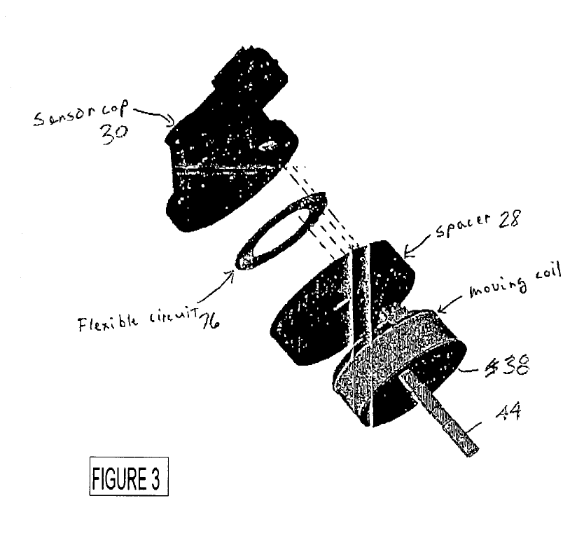

### DESCRIPTION OF THE PREFERRED EMBODIMENT

The drawings show an electric exhaust gas recirculation valve (EEGR valve) 10 intended for use with an internal combustion engine to control the flow of exhaust gas being recirculated from an exhaust system of the engine to an intake system of the engine.

Valve 10 comprises a body 12 containing a flow passage 13 extending between a valve inlet port 14 adapted to be communicated to the engine exhaust system and a valve outlet port 16 adapted to be communicated to the engine intake system.

Valve 10 further comprises an actuator 18, which is under control of an engine control system to control the extent to which valve 12 allows exhaust gas to be recirculated through flow passage 13. In the closed position of valve 12 that blocks exhaust gas recirculation, a valve element 20 of valve 12 is closing on a valve seat 22 in flow passage 13, closing the flow passage to flow of exhaust gas between ports 14 and 16.

As the engine control system delivers increasing electric current to actuator 18, a point is reached where the current is sufficiently large to create sufficient force for unseating valve element 20 from seat 22, thereby opening the valve. Further increases in current increasingly open the valve.

Actuator 18 comprises a multi-part housing 24 that includes a base 26, a spacer 28 and a cap 30. Base 26 is a generally cup-shaped part that has a flat bottom wall 32 and a circular cylindrical sidewall 34 that stands upright on bottom wall 32. Spacer 28 is a circular cylindrical part that stands on cup sidewall 32, and cap 30 forms a closure for the open upper end of spacer 28.

Actuator 18 and valve body 12 are assembled together and share a common imaginary centerline 36. The assembled parts 26, 28, and 30 enclose an interior space of actuator 18 housing an armature 38 that is movable along centerline 36. Armature 38 itself comprises several parts including a bobbin 40, an electromagnet coil 42, and an armature shaft 44. Bobbin 40 comprises a transverse wall 46 and a circular cylindrical sidewall 48 that depends from the outer margin of wall 46. The outer face of sidewall 48 comprises a recess containing coil 42. A material such as magnesium is suitable for bobbin 40.

Two additional parts 50 and 52 of actuator 18 cooperate with base 26 to form a stator of the actuator. Part 50 is a magnet that provides magnetic flux for the magnetic circuit formed by the stator. Parts 50 and 52 are stacked as shown on bottom wall 32 within the actuator interior space. The parts cooperatively define a circular cylindrical groove 54 concentric with centerline 36 within the actuator interior space. The three parts 32, 50, and 52 also cooperatively define a through-hole 56 on centerline 36. A bearing sleeve 58 is fit to through-hole 56 to provide guidance for the motion of armature shaft 44 along centerline 36. Armature shaft 44 extends completely through bearing sleeve 58, being suitably fastened or otherwise joined to valve element 20 at one end, and being fastened to the center of bobbin wall 46 at its other end. The latter fastening is accomplished by abutment of a shoulder on shaft 44 with one end of a hub 60 at the center of bobbin 40, and a retaining ring 62 that is assembled to shaft 44 to bear against wall 46 at the opposite end of hub 60, thereby capturing bobbin 40 on shaft 44.

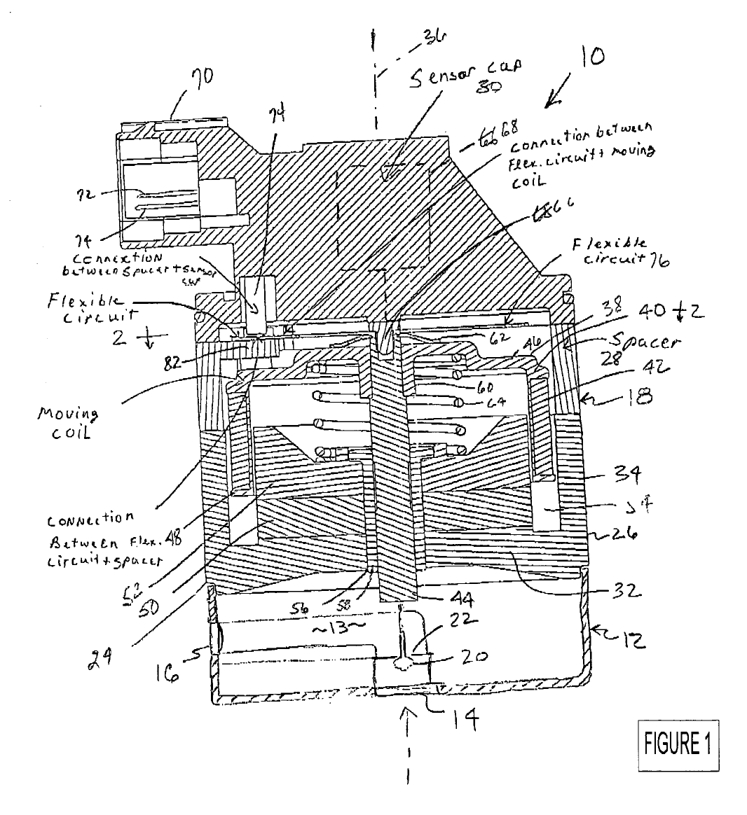

Armature 38 is spring-biased upwardly along centerline 36 by a helical coil spring 64 within actuator 18. A zone of bobbin wall 46 surrounding hub 60 is formed to provide a seat for one end of spring 64, while a confronting face of part 52 provides a seat for the opposite end of the spring. Spring 64 is partially axially compressed to exert an upward force that is effective to bias valve element 20 closed on seat 22 when coil 42 is not being energized. This is the position shown in FIG. 1.

The upward bias force being imparted to armature 38 by spring 64 also acts to position a plunger 66 of a position sensor 68 housed within cap 30. When the energization of coil 42 acts to move armature 38 downward to unseat valve element 20 from seat 22 and thereby open the valve, as will be more fully explained hereinafter, an internal spring within sensor 68 keeps plunger 66 biased against the end of shaft 44 so that sensor 68 faithfully tracks the position of armature 38 along centerline 36 and hence the extent to which the valve is open.

Cap 30 also comprises an electric connector 70 via which the engine control system delivers electric current to coil 42 and sensor 68 is read by the engine control system. Connector 70 contains two electric terminals 72, 74 for providing connection to opposite terminations of coil 42, and three terminals (not shown) associated with sensor 68. However, because armature 38 moves relative to cap 30 as coil 42 is energized, circuit continuity from the fixed terminals 72, 74 to the moving coil 42 must be provided, and it is such continuity that is provided by the present invention.

That continuity is provided by a flexible circuit 76 in the form of a flat, two-conductor insulated strip that has a circular arcuate shape about centerline 36 as viewed in the direction of the centerline. The strip contains two conductors 78, 80, each connecting a respective terminal 72, 74 and a respective termination of coil 42. In the illustrated embodiment, the flat strip has a width that is radial to centerline 36- and a length that is generally circumferential about centerline 36. The greater the circumferential extent of the strip, the less the strip will have to flex, and so it may be considered desirable for the strip to extend circumferentially as much as possible about the centerline. For example, short axial travel of the armature may allow the strip to have a circumferential extent in a range from about 90° to about 180°. For longer axial travel of the armature, the strip may have a circumferential extent greater than 180°. The strip is fabricated by known flexible circuit techniques and has appropriate terminations at the ends of the conductors 78, 80 for making connections with the cap terminals and the coil.

One end of circuit 76 is disposed on an overhang 82 on the upper rim of spacer 28. There, each of the two conductors 78, 80 makes connection with a respective one of the cap-mounted terminals 72, 74. The opposite end of circuit 76 is disposed on bobbin 40 where each of the two conductors 78, 80 makes connection with a respective termination of coil 42.

As the engine control system delivers increasing electric current to coil 42, the magnetic field that the coil generates interacts with the magnetic flux in the stator circuit across groove 54 to cause increasing downward force to be developed on armature 38, increasingly compressing spring 64 and increasingly opening the valve in the process. Flexible circuit 76 increasingly flexes in the process, but remains fully capable of carrying the electric current flow to the coil. An example of a suitable flexible conductor is a Novaclad brand of conductor.

While the foregoing has described a preferred embodiment of the present invention, it is to be appreciated that the inventive principles may be practiced in any form that falls within the scope of the following claims.

What is claimed is:

1. An electric-actuated automotive emission control valve comprising:
a valve body comprising a passageway having an inlet port for receiving fluid and an outlet port for delivering fluid;
a valve element that is selectively positioned to selectively restrict the passageway; and
a mechanism for selectively positioning the valve element comprising a solenoid actuator comprising a magnetic circuit that comprises a stator, an armature, and an electromagnet coil disposed on one of the stator and armature, with the stator, the armature, and the coil collectively arranged to cause the armature and the stator to be relatively positioned along an axis in correlation with electric current in the coil, and wiring for conducting the electric current between a termination at the coil and a termination at the other of the stator and the armature wherein the distance between the terminations, as measured along the axis, changes in correlation with the electric current, and the wiring has an arcuate shape about the axis as viewed in the direction of the axis.

2. An electric-actuated automotive emission control valve as set forth in claim 1 wherein the coil is disposed on the armature.

3. An electric-actuated automotive emission control valve as set forth in claim 2 wherein the axis along which the armature and the stator are relatively positioned is straight, and the wiring has a circular arcuate shape about the axis as viewed in the direction of the axis.

4. An electric-actuated automotive emission control valve as set forth in claim 3 wherein the wiring comprises a flat insulating strip within which are two conductors each connecting a respective terminal at one of the terminations and a respective terminal at the other of the terminations.

5. An electric-actuated automotive emission control valve as set forth in claim 4 wherein the flat strip has a width that is radial to the axis and a length that is generally circumferential about the axis.

6. An actuator for an electric-actuated control valve comprising:
a magnetic circuit that comprises a stator, an armature, and an electromagnet coil disposed on one of the stator and armature, with the stator, the armature, and the coil collectively arranged to cause the armature and the stator to be relatively positioned along an axis in correlation with electric current in the coil, and wiring for conducting the electric current between a termination at the coil and a termination at the other of the stator and the armature wherein the distance between the terminations, as measured along the axis, changes in correlation with the electric current, and the wiring has an arcuate shape about the axis as viewed in the direction of the axis.

7. An actuator as set forth in claim 6 wherein the coil is disposed on the armature.

8. An actuator as set forth in claim 7 wherein the axis along which the armature and the stator are relatively positioned is straight, and the wiring has a circular arcuate shape about the axis as viewed in the direction of the axis.

9. An actuator as set forth in claim 8 wherein the wiring comprises a flat insulating strip within which are two conductors each connecting a respective terminal at one of the terminations and a respective terminal at the other of the terminations.

10. An actuator as set forth in claim 9 wherein the flat strip has a width that is radial to the axis and a length that is generally circumferential about the axis.
